(19) United States
(12) Patent Application Publication
(10) Pub. No.: US 2013/0286193 A1
(43) Pub. Date: Oct. 31, 2013

(54) VEHICLE VISION SYSTEM WITH OBJECT DETECTION VIA TOP VIEW SUPERPOSITION

(71) Applicant: Magna Electronics Inc., Auburn Hills, MI (US)

(72) Inventor: Goerg Pflug, Weil der Stadt (DE)

(73) Assignee: MAGNA ELECTRONICS INC., Auburn Hills, MI (US)

(21) Appl. No.: 13/847,815

(22) Filed: Mar. 20, 2013

Related U.S. Application Data
(60) Provisional application No. 61/613,651, filed on Mar. 21, 2012.

(51) Int. Cl. B60R 1/00

(52) U.S. Cl. CPC B60R 1/002
USPC 348/135; 348/148

(57) ABSTRACT

A vehicle vision system includes at least two cameras having exterior fields of view and an image processor that processes captured image data and compares image data in overlapping regions of fields of views of two or more adjacent or neighboring cameras at a vehicle (such as a corner region near a corner of the vehicle where a portion of the field of view of a side camera of the vehicle overlaps a portion of the field of view of a front or rear camera of the vehicle). The system processes a common data sub-set and different data sub-sets of image data captured by the cameras at the overlapping regions, and processes the common data sub-set differently from the other data sub-sets. The system may generate a synthesized image derived from the data sub-sets for displaying images at a display screen for viewing by the driver of the vehicle.

### CROSS REFERENCE TO RELATED APPLICATION

The present application claims the filing benefit of U.S. provisional application, Ser. No. 61/613,651, filed Mar. 21, 2012, which is hereby incorporated herein by reference in its entirety.

### FIELD OF THE INVENTION

The present invention relates to imaging systems or vision systems for vehicles.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a vehicle vision system that is operable, via image processing of image data captured by one or more cameras of the vehicle, to detect an object in the field of view of one or more of the cameras.

According to an aspect of the present invention, a vehicle vision system includes at least two cameras having exterior fields of view (such as a forward viewing camera, opposite side viewing cameras and a rearward viewing camera) and an image processor that compares image data in overlapping regions of fields of views of two or more adjacent or neighboring cameras at a vehicle (such as image data at the corners of the vehicle). The system of the present invention subtracts common data or image portions at the overlapping regions, leaving and processing or analyzing the different data or image portions, which are indicative of generally vertical objects or edges or the like, because generally vertical objects or edges will be sheered or skewed relative to one another in captured images as captured by vehicle cameras mounted at distant positions from one another and angled relative to one another (such as cameras having a spherical or fisheye type lens or other distorting wide angle lens) having different but overlapping fields of view exterior of the vehicle.

The system may be operable to detect objects at side and rearward regions of the vehicle, such as during a reversing maneuver of the vehicle, and may display them to the driver of the vehicle, such as via a top down or surround view image, or via video images captured by the rearward facing camera, and optionally with the detected objects highlighted or demarcated to enhance the driver's cognitive awareness of the detected objects at the rear corner or corners of the vehicle.

Optionally, for example, and in accordance with the present invention, the vision system may comprise a first camera disposed at a first side of a vehicle and having a first field of view exterior and sideward of the vehicle, and a second camera (such as a front camera or a rear camera of the vehicle) disposed at the vehicle and having a second exterior field of view exterior of the vehicle. The first field of view of the first camera overlaps the second field of view of the second camera at a first overlapping region. The second camera and the first camera are operable to capture image data indicative of an object located at the first overlapping region. The first camera captures a first image data set of the object and the second camera captures a second image data set of the object. The first image data set and the second image data set both comprise a common sub-set of image data of the object. The first image data set further comprises a first sub-set of image data of the object and the second image data set further comprises a second sub-set of image data of the object. Both the first sub-set of image data of the object and the second sub-set of image data of the object differ from the common sub-set of image data of the object, and the first sub-set of image data of the object differs from the second sub-set of image data of the object. An image processor processes the common sub-set of image data of the object, the first sub-set of image data of the object and the second sub-set of image data of the object. The processing of the common sub-set of image data by the image processor differs from the processing of the first sub-set of image data by the image processor, and the processing of the common sub-set of image data by the image processor differs from processing of the second sub-set of image data by the image processor. The image processor may utilize the common sub-set of image data of the object, the first sub-set of image data and the second sub-set of image data of the object to synthesize an image of the object for display on a display screen viewable in an interior cabin of the vehicle by a driver normally operating the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system and imaging sensors or cameras that provide exterior fields of view in accordance with the present invention;

FIG. 2 is a diagram of an algorithm of the present invention that provides a four camera system, with I_{A}, I_{B}, I_{C}, I_{D} being the images captured by one of the cameras and with I_{(AB)}, I_{(BC)}, I_{(CD)}, I_{(DA)} being the resulting images after subtracting one overlapping area from one camera from a neighboring other;

FIG. 3 is a plan view of the vehicle, showing I_{A}, I_{B}, I_{D}, I_{D}, which are the images captured by four cameras mounted at and around the vehicles, with four overlapping areas which images might source the object identification algorithm, and with the system optionally ignoring the areas outside the overlapping areas for calculation;

FIG. 4 shows the overlapping areas as shown in FIG. 3;

FIG. 5 shows how an upright standing cylindrical object would sheer from an image captured by camera B to an image captured by camera A when generating a virtual top view image; and

FIG. 6 shows the scheme of FIG. 5, wherein a closest distance finding algorithm may find the distance “d” as the closest distance between a detected object and the vehicle or vehicle's extensions.

### DESCRIPTION OF THE PREFERRED EMBODIMENTS

A driver assist system and/or vision system and/or object detection system and/or alert system may operate to capture images or detect objects exterior of the vehicle and process the captured data to detect objects (at or near to ground) in front of the vehicle and in the predicted path of the vehicle, such as to alert the driver of the vehicle if the moving trajectory of the vehicle is pointing towards or into a detected object. The object detection may utilize detection and analysis of moving vectors representative of objects detected in the field of view of the vehicle camera, in order to determine which detected objects are objects of interest to the driver of the vehicle.

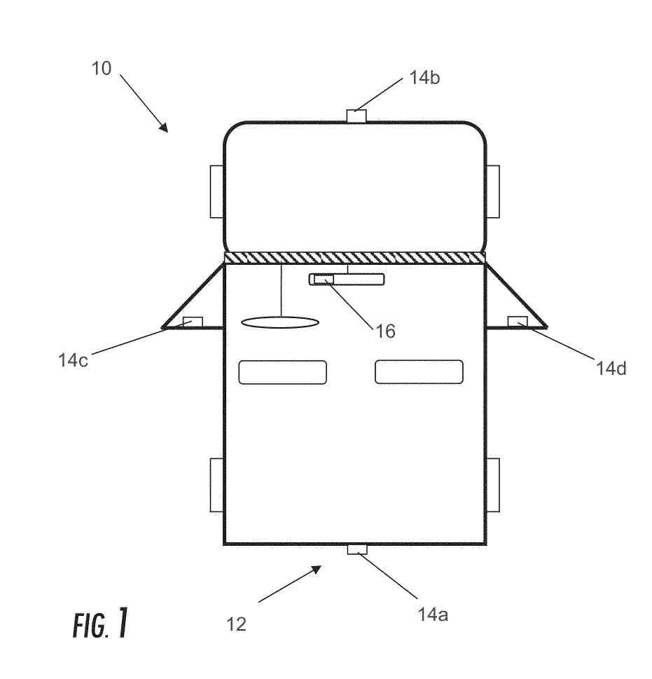

Referring now to the drawings and the illustrative embodiments depicted therein, a vehicle 10 includes a sensing system or imaging system or vision system 12 that includes one or more imaging sensors or cameras (such as a rearward facing imaging sensor or camera 14a and/or a forwardly facing camera 14b at the front of the vehicle, and/or a sidewardly/rearwardly facing camera 14c, 14b at the sides of the vehicle), which capture images exterior of the vehicle, with the cameras having a lens for focusing images at or onto an imaging array or imaging plane of the camera (FIG. 1). The sensing system 12 is operable to process image data captured by the forward facing sensor and may provide displayed images at a display device 16 for viewing by the driver of the vehicle. The sensing system processes captured data to detect objects, such as objects forward of the vehicle during forward driving or such as objects to the rear of the subject or equipped vehicle during a reversing maneuver, and includes a camera or camera module that has enhanced electrical connections within the camera housing, as discussed below.

Automotive camera vision systems are often used for determining objects (potential hazards) within the area surrounding the vehicle for preventing or avoiding collisions, such as, for example, during a reversing maneuver of the vehicle or the like. Automotive camera vision systems are typically capable of acknowledging the size and the distance of objects within the field of view area of the camera or cameras. Some (fully vision based) systems (without second depth sensors) solve this by a disparity analysis (stereo vision), computing the images of neighboring or adjacent front facing cameras. To use the disparity comparison, the images must be mostly dewarped, and fisheye images typically are not used. Typically, a horizontal view without fisheye lens cameras (having about a 160 degree to about a 200 degree opening angle), such as a horizontal view of cameras with normal opening angle (less than about 120 degrees), finds use when using stereo image depth determination.

Other algorithms use size comparison of known object sizes to unknown object sizes. Some systems may utilize the vehicle's own movement for computing the parallax changes to identifying the image's depth. Some systems may try to conclude that an object is vertical by the object's shadow since the sun's position at a certain time and location is known in relationship to the object's shadow length within a captured image.

Often, these algorithms require object discrimination and object tracking. For picking out objects within images, a common approach is to utilize edge detection, searching for distinctive marks, which highlight or distinguish the objects from the background scenery, and analyzing these objects and/or these objects' movements. All these methods either require complex or highly sophisticated hardware or require a substantial amount of computing power.

Some systems do not use just visual or video or imaging cameras, but use additional sensors (such as RADAR sensors, LIDAR, LADAR, time of flight (TOF), structured light or ultrasonic sensors or the like) for adding or detecting or plausible checking vertical object's distances. Often, blind spot zones become covered by additional sensors, with radar and ultrasound sensors being commonly used in such vehicle systems.

The present invention provides a method to determine vertical objects captured by one or more cameras at the vehicle (such as by cameras having fisheye lenses or otherwise capturing distorted images) using low calculation efforts, either in sensor fusion or as a stand alone system. Blind spot regions shall become widely eliminated by application of the vision system of the present invention.

Distances to hazarding objects are much better recognizable to the user within a top view visualization than shown within horizontal views. The detour of analyzing horizontal views on hazards when presenting a top view to the driver may be overcome by application of the vision system of the present invention.

The present invention provides a vehicle vision system that uses images captured by multiple cameras, such as four fish eye lens cameras that are located around the car in angles of typically about 90 degrees relative to one another in a Z axis, such as a rear camera having a rearward field of view, a driver side camera at the driver side of the vehicle and having a sideward field of view, a passenger side camera at the passenger side of the vehicle and having a sideward field of view, and a front camera having a forward field of view. It is known to dewarp and rectify the fish eye images and to generate an artificial (virtual) external view representative of a top down view of the vehicle, such as if the viewer were looking at the vehicle from an elevated position top down. In vision systems often these top view images become cropped and stitched to generate a top view of the whole surrounding of the vehicle.

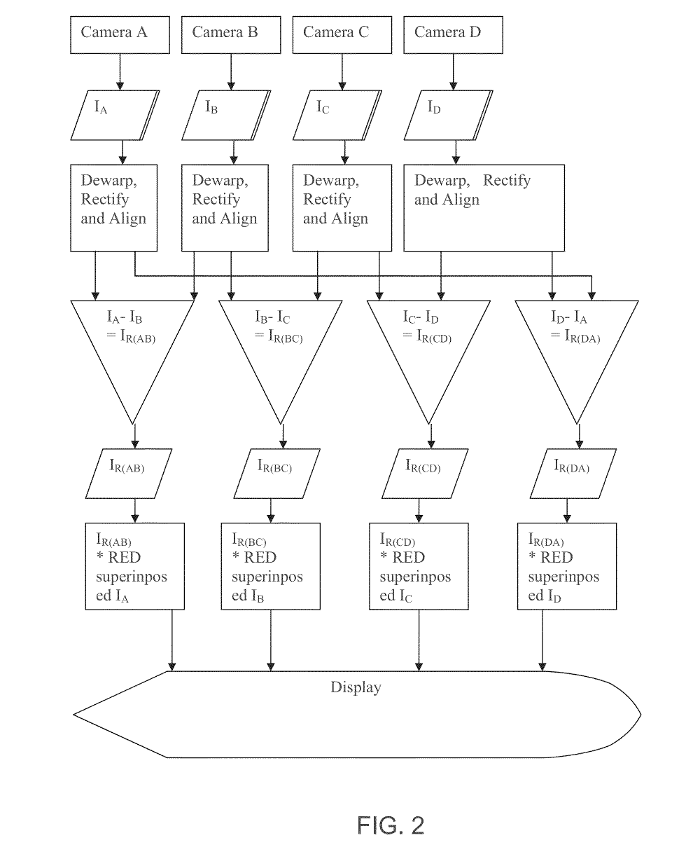

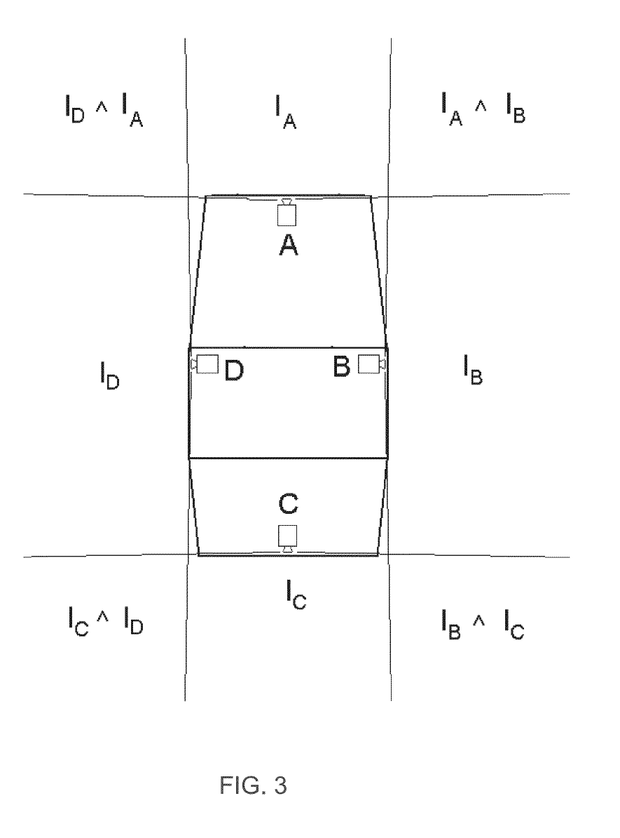

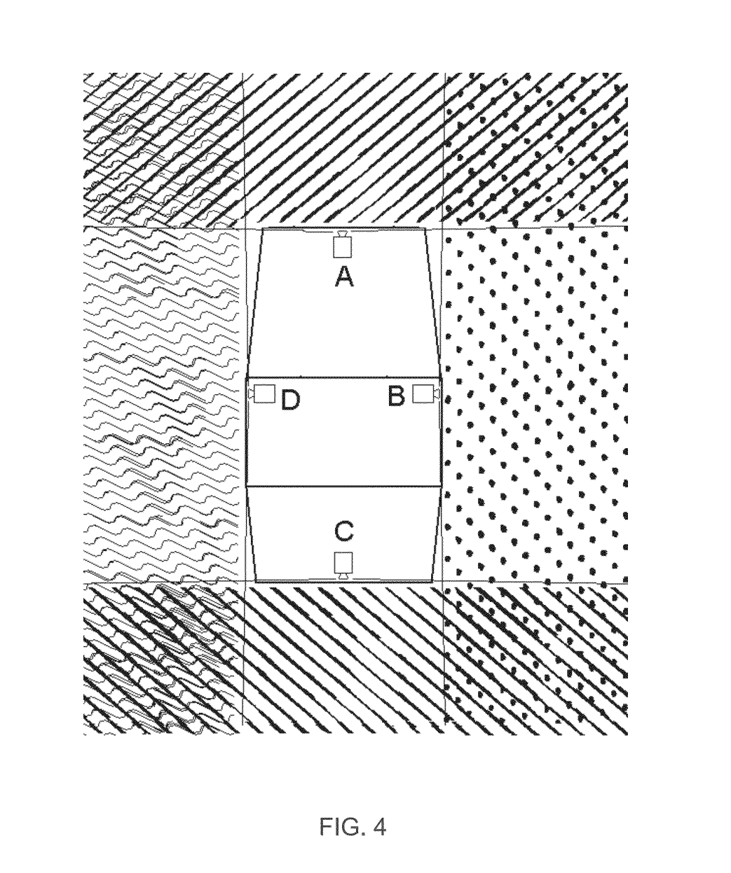

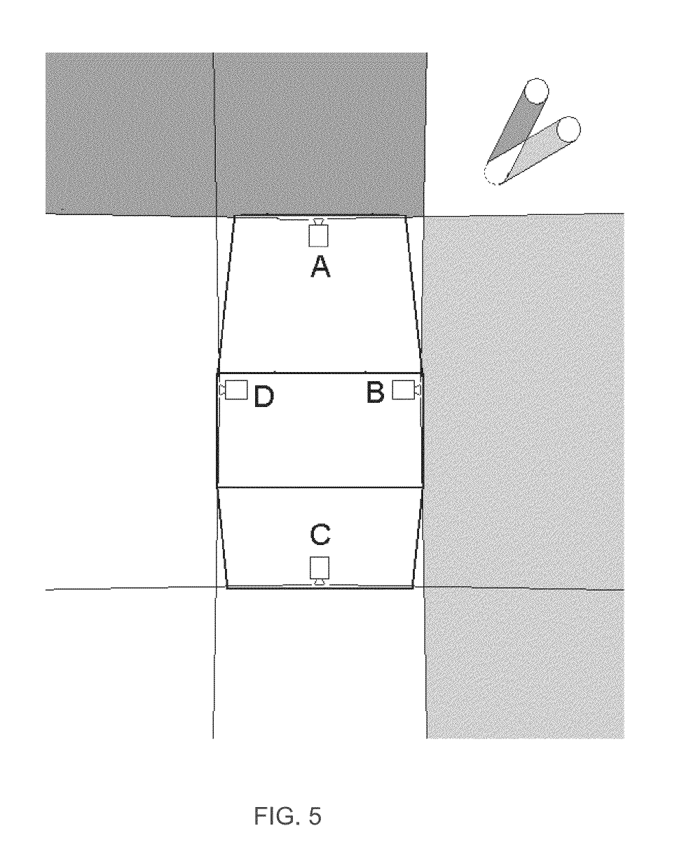

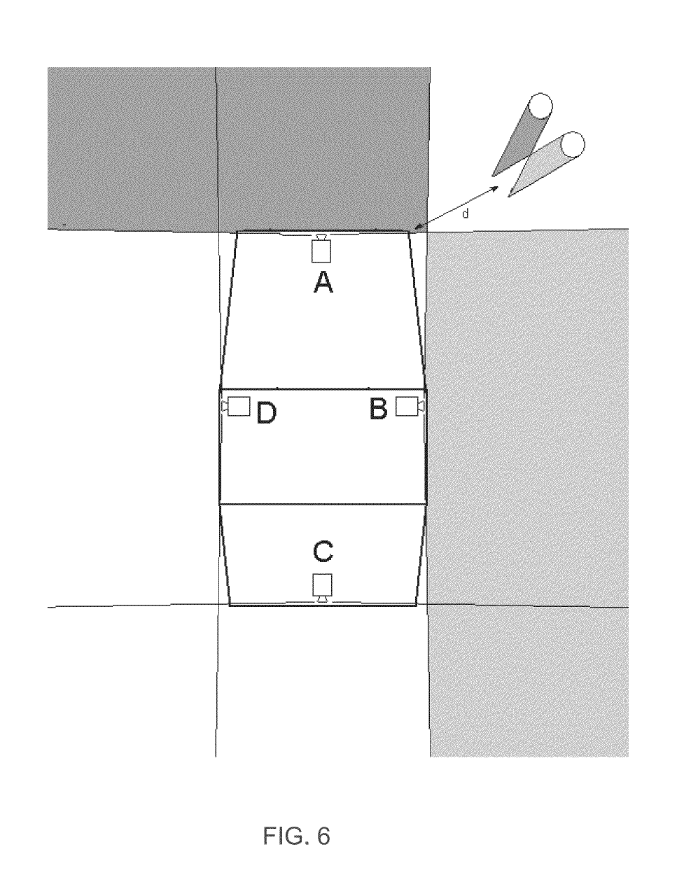

Apart from known stereo camera image depth detection (where images of the horizontal scenery become processed), the inventive solution may be to do a disparity analysis on the image data which is already transferred into the virtual top view. Instead of cropping the images, the overlapping of the cameras' views becomes capitalized. On a four camera vision system (such as shown in FIGS. 1 and 3-5), there is an overlapping zone of two cameras on each edge or corner of the vehicle. On every edge or corner, both images (such as I_{A} and I_{B} in FIG. 3) become superimposed aligning and within the same size ratio, so matching. By using a vision algorithm, both regions may become pixel wise subtracted from one another. For clearer results, the portions of both images may be blurred (by pixel count reduction or mosaicing or Gauss filtering or the like) before subtracting (optional). This may be done in gray scale or in one color channel (such as RGB or YUV), and/or two or all three or all, either at once or separate, may be processed. The result (Iᵣ) is the differing of both images (I_{A} and I_{B}) scenes (FIG. 2). Identical areas or pixels become eliminated while differing areas or pixels remain. Assuming the cameras are calibrated well, the areas (shapes) of the scenery on the ground should become eliminated, since these have no disparity to each other (for example, the shape of a child painted to the ground will disappear in the difference image). Objects which have a vertical component (Z axis), so standing upright, will be sheered away from the top view image's center (which usually equates to the vehicle's center) or varied relative to one another in the different images (such as can be seen with reference to FIGS. 5 and 6). The base point (at or near the ground) may be identical (so it will be subtracted or eliminated), and only the sheering or differing pixels will remain after subtracting both images. These pixels may become used as an indicator for objects which have a vertical extension (z-dimension component).

For example, and with reference to FIG. 5, the front camera A may capture image data of the rear scene, and that image data may include a data set having data points indicative of or representative of an object in the overlapping region (where the fields of view of the front camera A and the side camera B overlap), while the side camera B captures image data that includes a data set having data points indicative of or representative of the object in the overlapping region. The first image data set captured by the front camera and the second image data set captured by the side camera include common data points indicative of a portion of the object. The image processor at least substantially ignores the common data points of the first and second image data sets, and the image processor processes other data points of the first and third image data sets to determine an orientation of the object at the overlapping region, such as to determine a vertical component of the determined object.

Optionally, so as to highlight the object's area, one color (such as, for example, red or any other suitable or selected color) of the original top view image (I_{A} or I_{B}) may be multiplied by the subtraction result (Iᵣ), causing the color component to increase at the concerning spots. Such coloring assists in alerting the driver of the vehicle as to the presence of the object at the corner region of the vehicle, such as by displaying the detected object in a different color (such as red) at a video display screen or the like. Thus, the driver of the vehicle, such as when executing a reversing maneuver, can readily identify a colored object shown in the captured rearward video images and shown on a video display screen, such as a video display screen of a video mirror assembly of the vehicle that is readily viewable by the driver during the reversing maneuver.

Since vertical distances on the ground are displayed in a virtual top view as if looking onto a real image from over top, the distances (such as distance “d” in FIG. 6) of the highlighted blobs are plausible to a human eye. Optionally, a machine vision algorithm may run a shortest distance search between the vehicle or vehicle's extensions and the object's points found in the difference images. The system may provide closing warnings or alerts to the driver of the vehicle or may run a collision avoidance algorithm based on that closest distance. These algorithms may function without doing a 3D world reconstruction and without further knowledge of the detected objects beside the determination that the detected object is vertical or has a vertical depth or component. The system furthermore may employ a motion detection system or algorithm, which detects the ego motion of the vehicle relative to the ground and stores and virtually tracks the ground position of objects found in the difference images in the overlapping areas, and thus can track when these objects are leaving the overlapping area and entering areas in front of, rearward of or sideward of the vehicle (area I_{A}, I_{B}, I_{C} or I_{D} according FIG. 3), where the object image may be captured by none (apart from above examples) or just one camera according the example in FIGS. 3-6. Thus, when the tracked object is at an area where its image is captured by only one camera (or no camera), the system may know (based on the previous determination) that the object has a vertical depth or vertical component.

To cope with the problem that small differences between two cameras' images caused by inaccurate dewarping, rectifying and/or aligning, there may be optical noise in the resulting image after subtracting, the system of the present invention may utilize a filter. Since the falsely differences between the cameras are typically static, the difference-image may be stored as a filter. The filter may be calibrated at a time when no objects are within range or by a low pass filter which stores the differences which are always present over a substantially long time. As soon calibrated, this filtered image content (I_{f}) becomes subtracted from the resulting (Iᵣ), called ‘calibrated object indication image’ (Iᵣ−I_{f}=lₐ), and the real existing differences only remain. To enhance this filtering, a pixel reduction may find use which helps to eliminate small misalignments, but may still detect objects of reasonable size.

Object detection and tracking algorithms often suffer under image complexity to differentiate real objects from shapes on the ground and the like. Further embodiments of the present invention may use the object indication algorithm to point out objects which are preferable to regard by the object detection algorithm which might work within the horizontal view (regions of interest). Also, the algorithm of the present invention may be used for covering or highlighting the blind spot areas at or near or on the edges or corners of the vehicle, which may not be encompassed or protected well by other sensors. Optionally, the algorithm of the present invention may find use for supporting a surround vision system camera (online) calibration.

Therefore, the present invention provides a vehicle vision system that compares image data in overlapping regions of fields of views of two or more cameras at a vehicle (such as image data at the corners of the vehicle). The system of the present invention subtracts common data or image portions at the overlapping regions, leaving different data or image portions, which are indicative of generally vertical objects or edges or the like, because generally vertical objects or edges will be sheered or skewed relative from one another in captured images as captured by vehicle cameras (such as having a spherical or fisheye type lens or other distorting wide angle lens) having different but overlapping fields of view exterior of the vehicle.

The camera or cameras may include or may be associated with an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The camera or imager or imaging sensor may comprise any suitable camera or imager or sensor. Optionally, the camera may comprise a “smart camera” that includes the imaging sensor array and associated circuitry and image processing circuitry and electrical connectors and the like as part of a camera module, such as by utilizing aspects of the vision systems described in PCT Application No. PCT/US2012/066571, filed Nov. 27, 2012 (Attorney Docket MAG04 FP-1961(PCT)), which is hereby incorporated herein by reference in its entirety.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, an array of a plurality of photosensor elements arranged in at least about 640 columns and 480 rows (at least about a 640×480 imaging array), with a respective lens focusing images onto respective portions of the array. The photosensor array may comprise a plurality of photosensor elements arranged in a photosensor array having rows and columns. The logic and control circuit of the imaging sensor may function in any known manner, and the image processing and algorithmic processing may comprise any suitable means for processing the images and/or image data. For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, PCT Application No. PCT/US2010/047256, filed Aug. 31, 2010 and published Mar. 10, 2011 as International Publication No. WO 2011/028686 and/or International Publication No. WO 2010/099416, published Sep. 2, 2010, and/or PCT Application No. PCT/US10/25545, filed Feb. 26, 2010 and published Sep. 2, 2010 as International Publication No. WO 2010/099416, and/or PCT Application No. PCT/US2012/048800, filed Jul. 30, 2012 (Attorney Docket MAG04 FP-1908(PCT)), and/or PCT Application No. PCT/US2012/048110, filed Jul. 25, 2012 (Attorney Docket MAG04 FP-1907(PCT)), and/or PCT Application No. PCT/CA2012/000378, filed Apr. 25, 2012 (Attorney Docket MAG04 FP-1819(PCT)), and/or PCT Application No. PCT/US2012/056014, filed Sep. 19, 2012 (Attorney Docket MAG04 FP-1937(PCT)), and/or PCT Application No. PCT/US12/57007, filed Sep. 25, 2012 (Attorney Docket MAG04 FP-1942(PCT)), and/or PCT Application No. PCT/US2012/061548, filed Oct. 24, 2012 (Attorney Docket MAG04 FP-1949(PCT)), and/or PCT Application No. PCT/US2012/062906, filed Nov. 1, 2012 (Attorney Docket MAG04 FP-1953(PCT)), and/or PCT Application No. PCT/US2012/063520, filed Nov. 5, 2012 (Attorney Docket MAG04 FP-1954(PCT)), and/or PCT Application No. PCT/US2012/064980, filed Nov. 14, 2012 (Attorney Docket MAG04 FP-1959(PCT)), and/or PCT Application No. PCT/US2012/066570, filed Nov. 27, 2012 (Attorney Docket MAG04 FP-1960(PCT)), and/or PCT Application No. PCT/US2012/066571, filed Nov. 27, 2012 (Attorney Docket MAG04 FP-1961(PCT)), and/or PCT Application No. PCT/US2012/068331, filed Dec. 7, 2012 (Attorney Docket MAG04 FP-1967(PCT)), and/or PCT Application No. PCT/US2012/071219, filed Dec. 21, 2012 (Attorney Docket MAG04 FP-1982(PCT)), and/or PCT Application No. PCT/US2013/022119, filed Jan. 18, 2013 (Attorney Docket MAG04 FP-1997(PCT)), and/or PCT Application No. PCT/US2013/026101, filed Feb. 14, 2013 (Attorney Docket MAG04 FP-2010(PCT)), and/or PCT Application No. PCT/US2013/027342, filed Feb. 22, 2013 (Attorney Docket MAG04 FP-2014(PCT)), and/or U.S. patent application Ser. No. 13/785,099, filed Mar. 5, 2013 (Attorney Docket MAG04 P-2017); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional applications, Ser. No. 61/766,883, filed Feb. 20, 2013; Ser. No. 61/760,368, filed Feb. 4, 2013; Ser. No. 61/760,364, filed Feb. 4, 2013; Ser. No. 61/758,537, filed Jan. 30, 2013; Ser. No. 61/754,8004, filed Jan. 21, 2013; Ser. No. 61/745,925, filed Dec. 26, 2012; Ser. No. 61/745,864, filed Dec. 26, 2012; Ser. No. 61/736,104, filed Dec. 12, 2012; Ser. No. 61/736,103, filed Dec. 12, 2012; Ser. No. 61/735,314, filed Dec. 10, 2012; Ser. No. 61/734,457, filed Dec. 7, 2012; Ser. No. 61/733,598, filed Dec. 5, 2012; Ser. No. 61/733,093, filed Dec. 4, 2012; Ser. No. 61/727,912, filed Nov. 19, 2012; Ser. No. 61/727,911, filed Nov. 19, 2012; Ser. No. 61/727,910, filed Nov. 19, 2012; Ser. No. 61/718,382, filed Oct. 25, 2012; Ser. No. 61/710,924, filed Oct. 8, 2012; Ser. No. 61/696,416, filed Sep. 4, 2012; Ser. No. 61/682,995, filed Aug. 14, 2012; Ser. No. 61/682,486, filed Aug. 13, 2012; Ser. No. 61/680,883, filed Aug. 8, 2012; Ser. No. 61/676,405, filed Jul. 27, 2012; Ser. No. 61/666,146, filed Jun. 29, 2012; Ser. No. 61/648,744, filed May 18, 2012; Ser. No. 61/624,507, filed Apr. 16, 2012; Ser. No. 61/616,126, filed Mar. 27, 2012; and/or Ser. No. 61/615,410, filed Mar. 26, 2012, which are all hereby incorporated herein by reference in their entireties. The system may communicate with other communication systems via any suitable means, such as by utilizing aspects of the systems described in PCT Application No. PCT/US10/038,477, filed Jun. 14, 2010, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,123,168; 7,004,606; 6,946,978; 7,038,577; 6,353,392; 6,320,176; 6,313,454; and 6,824,281, and/or International Publication No. WO 2010/099416, published Sep. 2, 2010, and/or PCT Application No. PCT/US10/47256, filed Aug. 31, 2010 and published Mar. 10, 2011 as International Publication No. WO 2011/028686, and/or U.S. patent application Ser. No. 12/508,840, filed Jul. 24, 2009, and published Jan. 28, 2010 as U.S. Pat. Publication No. US 2010-0020170, and/or PCT Application No. PCT/US2012/048110, filed Jul. 25, 2012 (Attorney Docket MAG04 FP-1907(PCT)), and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. patent application Ser. No. 12/091,359, filed Apr. 24, 2008 and published Oct. 1, 2009 as U.S. Publication No. US-2009-0244361, and/or Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; and/or 7,720,580, and/or U.S. patent application Ser. No. 10/534,632, filed May 11, 2005, now U.S. Pat. No. 7,965,336; and/or PCT Application No. PCT/US2008/076022, filed Sep. 11, 2008 and published Mar. 19, 2009 as International Publication No. WO/2009/036176, and/or PCT Application No. PCT/US2008/078700, filed Oct. 3, 2008 and published Apr. 9, 2009 as International Publication No. WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,720,580; 7,038,577; 5,929,786 and/or 5,786,772, and/or U.S. patent application Ser. No. 11/239,980, filed Sep. 30, 2005, now U.S. Pat. No. 7,881,496, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. patent application Ser. No. 11/226,628, filed Sep. 14, 2005 and published Mar. 23, 2006 as U.S. Publication No. US-2006-0061008, and/or Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in PCT Application No. PCT/US2011/056295, filed Oct. 14, 2011 and published Apr. 19, 2012 as International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in PCT Application No. PCT/US10/25545, filed Feb. 26, 2010 and published on Sep. 2, 2010 as International Publication No. WO 2010/099416, and/or PCT Application No. PCT/US10/47256, filed Aug. 31, 2010 and published Mar. 10, 2011 as International Publication No. WO 2011/028686, and/or PCT Application No. PCT/US2011/062834, filed Dec. 1, 2011 and published Jun. 7, 2012 as International Publication No. WO2012/075250, and/or PCT Application No. PCT/US2012/048993, filed Jul. 31, 2012 (Attorney Docket MAG04 FP-1886(PCT)), and/or PCT Application No. PCT/US11/62755, filed Dec. 1, 2011 and published Jun. 7, 2012 as International Publication No. WO 2012-075250, and/or PCT Application No. PCT/CA2012/000378, filed Apr. 25, 2012 (Attorney Docket MAG04 FP-1819(PCT)), and/or PCT Application No. PCT/US2012/066571, filed Nov. 27, 2012 (Attorney Docket MAG04 FP-1961(PCT)), and/or U.S. patent application Ser. No. 13/333,337, filed Dec. 21, 2011 (Attorney Docket DON01 P-1797), and/or U.S. provisional applications, Ser. No. 61/615,410, filed Mar. 26, 2012, which are hereby incorporated herein by reference in their entireties.

The side cameras may be disposed at any suitable location at the side of the vehicle. For example, the side cameras may be disposed at an exterior rearview mirror assembly of the vehicle, such as by utilizing aspects of the vision systems described in U.S. Pat. Nos. 8,066,415; 8,262,268; and/or 7,720,580, and/or U.S. patent application Ser. No. 12/508,840, filed Jul. 24, 2009 (Attorney Docket MAG04 P-1541), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. patent application Ser. No. 12/091,525, filed Apr. 25, 2008, now U.S. Pat. No. 7,855,755; Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. patent application Ser. No. 10/538,724, filed Jun. 13, 2005 and published Mar. 9, 2006 as U.S. Publication No. US-2006-0050018, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. A vehicle vision system comprising:
a first camera disposed at a first side of a vehicle equipped with said vehicle vision system and having a first field of view exterior and sideward of the equipped vehicle;
a second camera disposed at the equipped vehicle and having a second exterior field of view exterior of the equipped vehicle;
wherein said first field of view of said first camera overlaps said second field of view of said second camera at a first overlapping region;
wherein said second camera and said first camera are operable to capture image data indicative of an object located at the first overlapping region;
wherein said first camera captures a first image data set of the object and said second camera captures a second image data set of the object;
wherein said first image data set and said second image data set both comprise a common sub-set of image data of the object;
wherein said first image data set further comprises a first sub-set of image data of the object and wherein said second image data set further comprises a second sub-set of image data of the object;
wherein both said first sub-set of image data of the object and said second sub-set of image data of the object differ from said common sub-set of image data of the object;
wherein said first sub-set of image data of the object differs from said second sub-set of image data of the object;
wherein an image processor processes said common sub-set of image data of the object, said first sub-set of image data of the object and said second sub-set of image data of the object;
wherein processing of said common sub-set of image data by said image processor differs from processing of said first sub-set of image data by said image processor and wherein processing of said common sub-set of image data by said image processor differs from processing of said second sub-set of image data by said image processor; and
wherein said image processor utilizes said common sub-set of image data of the object, said first sub-set of image data and said second sub-set of image data of the object to synthesize an image of the object for display on a display screen viewable in an interior cabin of the equipped vehicle by a driver normally operating the equipped vehicle.

2. The vehicle vision system of claim 1, wherein said image processor processes said first and second sub-sets of image data to determine an orientation of the object at the first overlapping region.

3. The vehicle vision system of claim 1, comprising a third camera disposed at a second side of the equipped vehicle and having a third field of view exterior and sideward of the equipped vehicle at an opposite side of the equipped vehicle from said first camera, wherein said third field of view of said third camera at least partially overlaps said second field of view of said second camera at a second overlapping region, and wherein said image processor is operable to process image data captured by said third camera.

4. The vehicle vision system of claim 3, comprising a fourth camera having a fourth field of view exterior of the equipped vehicle, wherein said fourth field of view at least partially overlaps said first field of view of said first camera at a third overlapping region and at least partially overlaps said third field of view of said third camera at a fourth overlapping region, and wherein said image processor is operable to process image data captured by said fourth camera.

5. The vehicle vision system of claim 4, wherein each of said cameras includes a wide angle lens.

6. The vehicle vision system of claim 1, wherein said first sub-set of image data and said second sub-set of image data are processed by said image processor to determine at least one of (i) a vertical component of the object present in said first overlapping region and (ii) an edge of the object present in said first overlapping region.

7. The vehicle vision system of claim 6, wherein said vehicle vision system is operable to track an object that is determined to have a vertical component.

8. The vehicle vision system of claim 6, wherein said display screen comprises a video display screen for displaying video images derived from image data captured by at least said second camera, and wherein said vehicle vision system is operable to highlight objects.

9. The vehicle vision system of claim 1, wherein said vehicle vision system is operable to determine a distance between the equipped vehicle and the object present at said first overlapping region, and wherein said vehicle vision system is operable to generate an alert to the driver of the equipped vehicle responsive to the determined distance being less than a threshold distance.

10. The vehicle vision system of claim 1, wherein said first camera is disposed at an exterior rearview mirror assembly at the first side of the equipped vehicle.

11. A vehicle vision system comprising:
a first side camera disposed at a first side of a vehicle equipped with said vehicle vision system and having a first field of view exterior and sideward of the equipped vehicle;
a rear camera disposed at a rear portion of the equipped vehicle and having a second exterior field of view exterior and rearward of the equipped vehicle;
wherein said first field of view of said first camera overlaps said second field of view of said second camera at a first overlapping region;
wherein said rear camera and said first side camera are operable to capture image data indicative of an object located at the first overlapping region;
wherein said first side camera captures a first image data set of the object and said rear camera captures a second image data set of the object;
wherein said first image data set and said second image data set both comprise a common sub-set of image data of the object;
wherein said first image data set further comprises a first sub-set of image data of the object and wherein said second image data set further comprises a second sub-set of image data of the object;
wherein both said first sub-set of image data of the object and said second sub-set of image data of the object differ from said common sub-set of image data of the object;
wherein said first sub-set of image data of the object differs from said second sub-set of image data of the object;
wherein an image processor processes said common sub-set of image data of the object, said first sub-set of image data of the object and said second sub-set of image data of the object;
wherein processing of said common sub-set of image data by said image processor differs from processing of said first sub-set of image data by said image processor and wherein processing of said common sub-set of image data by said image processor differs from processing of said second sub-set of image data by said image processor; and
wherein said image processor utilizes said common sub-set of image data of the object, said first sub-set of image data and said second sub-set of image data of the object to synthesize an image of the object for display on a display screen viewable in an interior cabin of the equipped vehicle by a driver normally operating the equipped vehicle.

12. The vehicle vision system of claim 11, wherein said first sub-set of image data and said second sub-set of image data are processed by said image processor to determine at least one of (i) a vertical component of the object present in said first overlapping region and (ii) an edge of the object present in said first overlapping region.

13. The vehicle vision system of claim 12, wherein said vehicle vision system is operable to track an object that is determined to have a vertical component.

14. The vehicle vision system of claim 11, wherein said display screen comprises a video display screen for displaying images captured by said second camera during a reversing maneuver of the vehicle.

15. The vehicle vision system of claim 14, wherein said system emphasizes an object present in the overlapping region, such as via a graphic overlay or via coloring the object so as to highlight the object as displayed by said video display.

16. A vehicle vision system comprising:
a first camera disposed at the equipped vehicle and having a first field of view exterior of the equipped vehicle;
a second camera disposed at the equipped vehicle and having a second field of view exterior of the equipped vehicle;
a third camera disposed at the equipped vehicle and having a third field of view exterior of the equipped vehicle;
a fourth camera disposed at the equipped vehicle and having a fourth field of view exterior of the equipped vehicle;
wherein said first field of view of said first camera overlaps said second field of view of said second camera at a first overlapping region and wherein said second field of view of said second camera overlaps said third field of view of said third camera at a second overlapping region and wherein said third field of view of said third camera overlaps said fourth field of view of said fourth camera at a third overlapping region and wherein said fourth field of view of said fourth camera overlaps said first field of view of said first camera at a fourth overlapping region;
wherein said second camera and said first camera are operable to capture image data indicative of an object located at the first overlapping region;
wherein said first camera captures a first image data set of the object and said second camera captures a second image data set of the object;
wherein said first image data set and said second image data set both comprise a common sub-set of image data of the object;
wherein said first image data set further comprises a first sub-set of image data of the object and wherein said second image data set further comprises a second sub-set of image data of the object;
wherein both said first sub-set of image data of the object and said second sub-set of image data of the object differ from said common sub-set of image data of the object;
wherein said first sub-set of image data of the object differs from said second sub-set of image data of the object;
wherein an image processor processes said common sub-set of image data of the object, said first sub-set of image data of the object and said second sub-set of image data of the object;
wherein processing of said common sub-set of image data by said image processor differs from processing of said first sub-set of image data by said image processor and wherein processing of said common sub-set of image data by said image processor differs from processing of said second sub-set of image data by said image processor; and
wherein said image processor utilizes said common sub-set of image data of the object, said first sub-set of image data and said second sub-set of image data of the object to synthesize an image of the object for display on a display screen viewable in an interior cabin of the equipped vehicle by a driver normally operating the equipped vehicle.

17. The vehicle vision system of claim 16, wherein said first sub-set of image data and said second sub-set of image data are processed by said image processor to determine at least one of (i) a vertical component of the object present in said first overlapping region and (ii) an edge of the object present in said first overlapping region.

18. The vehicle vision system of claim 17, wherein said vehicle vision system is operable to track an object that is determined to have a vertical component.

19. The vehicle vision system of claim 16, wherein one of said first, second, third and fourth cameras comprises a rear camera having a rearward field of view exterior of the equipped vehicle and another of said first, second, third and fourth cameras comprises a front camera having a forward field of view exterior of the equipped vehicle.

20. The vehicle vision system of claim 19, wherein the others of said first, second, third and fourth cameras comprise side cameras disposed at respective exterior rearview mirror assemblies at respective sides of the equipped vehicle and having respective sideward fields of view exterior of the equipped vehicle.
